(19) United States
(12) Patent Application Publication
(10) Pub. No.: US 2004/0229605 A1
(43) Pub. Date: Nov. 18, 2004

(54) Method for transmitting MBMS paging information in a mobile communication system

(75) Inventors: Sung-Oh Hwang, Yongin-si (KR); Sung-Ho Choi, Suwon-si (KR); Kook-Heui Lee, Yongin-si (KR); Eun-Jung Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/842,858

(22) Filed: May 11, 2004

(30) Foreign Application Priority Data
May 14, 2003 (KR) 30719-2003

(51) Int. Cl. H04Q 7/20

(52) U.S. Cl. 455/426.1; 455/458

(57) ABSTRACT

A mobile communication system includes a radio network controller (RNC), at least one Node B, and at least one user equipment (UE) able to receive a broadcast service from the Node B. The RNC generates a paging control frame based on the paging information including paging indicator bit mapping information indicating paging for each broadcast service; transmits the paging control frame to the Node B; and receives a response message to the paging control frame from the Node B. The Node B receives paging information including paging indicator bit mapping information indicating paging for each broadcast service, from the RNC through a paging control frame; transmits a response message including the paging information to the RNC in response to the paging control frame; and transmits the paging indicator to the UE based on the paging information.

### PRIORITY

This application claims priority under 35 U.S.C. §119 to an application entitled “Method for Transmitting MBMS Paging Information in a Mobile Communication System” filed in the Korean Intellectual Property Office on May 14, 2003 and assigned Serial No. 2003-30719, the contents of which are incorporated herein by reference.

### BACKGROUND OF THE INVENTION

1. Field of the Invention

The present invention relates generally to a broadcast service in a mobile communication system, and in particular, to a method for transmitting paging information for a broadcast service.

2. Description of the Related Art

Due to the rapid development of communication technologies, mobile communication systems are developing into advanced service systems for transmitting not only existing voice service data but also mass data such as packet data and circuit data. In addition, the existing services are evolving into multicasting multimedia communication systems capable of transmitting multimedia service data. Active research is being conducted on Multimedia Broadcast/Multicast Service (MBMS) provided from one or multiple multimedia data services to multiple user equipments (UEs). The MBMS service requires great amounts of transmission resources because it supports transmission of multimedia information, such as real-time image and voice, still image, and text. The MBMS service usually utilizes a broadcast channel as many services need to be simultaneously provided in the same cell. In addition, the MBMS service can employ a point-to-point (PtP) mode for individually providing a specific service to a particular UE and a Point-to-Multipoint (PtM) mode for providing the same service to multiple UEs. The PtP mode and the PtM mode can be selectively used based on the number of UEs located in each cell and their transmission power.

FIG. 1 is a diagram illustrating a 3GPP (3^{rd} Generation Partnership Project) asynchronous communication system to which an MBMS service is applied. Referring to FIG. 1, a broadcast/multicast-service center (BM-SC) 106 provides an MBMS stream. The MM-SC 106 schedules the MBMS stream and delivers the scheduled MBMS stream to a gateway GPRS (General Packet Radio Service) support node (GGSN) 105. The GGSN 105 delivers the MBMS stream from the BM-SC 106 to a serving GPRS support node (SGSN) 103.

The SGSN 103 belongs to a core network (CN), and connects the CN to a UMTS (Universal Mobile Telecommunications System) terrestrial radio access network (UTRAN) 102. The SGSN 103 controls UEs to receive an MBMS service. For example, the SGSN 103 manages MBMS service accounting-related data of each UE, and selectively transmits the MBMS stream to the UTRAN 102. In addition, the SGSN 103 forms a service context for each MBMS service and manages the service context. The service context for an MBMS service will be referred to as “MBMS service context.” The MBMS service context refers to a set of control information necessary for providing a particular MBMS service. A home location register (HLR) 104 connected to the SGSN 103 performs subscriber authentication for the MBMS service.

The UTRAN 102 connects a UE 101 to the SGSN 103 The UTRAN 102 forwards a MBMS service request from the UE 101 to the SGSN 103, and forwards an MBMS stream from the SGSN 103 to the UE 101.

The UE 101, a user terminal, receives an MBMS service, and contains hardware and software for supporting the MBMS service.

The UE 101 is connected to the UTRAN 102 via a Uu interface 121. The Uu interface 121, a term used in 3GPP, refers to an interface between a UE and a UTRAN.

The UTRAN 102 is connected to the SGSN 103 via an Iu interface 122. The Iu interface 122, a term used in 3GPP, refers to an interface between a UTRAN and an element in a CN.

Table 1 below illustrates functions of respective elements for providing an MBMS service, shown in FIG. 1.

TABLE 1

| Reference | | |
|---|---|---|
| Numeral | Name | Function |
| 101 | UE | Receives an MBMS service and allows users to |
| | | use the MBMS service. |
| 102 | UTRAN | Delivers MBMS data to UE, and delivers an |
| | | MBMS request from a UE to a CN. |
| 103 | SGSN | Authenticates a UE requiring an MBMS |
| | | service based on data received from HLR. |
| | | Authenticates a UE based on a right to use an |
| | | MBMS service requested by the UE, received |
| | | from HLR. Sets up a radio connection bearer for |
| | | an MBMS service requested by a UE. |
| | | Supports an MBMS service even when a UE |
| | | moves from cell to cell. |
| | | Connects with an MBMS source via a GGSN. |
| | | Collects accounting information for an MBMS |
| | | service used by a UE. |
| 104 | HLR | Manages authentication information for each |
| | | UE and information on the type of an MBMS |
| | | service that each UE can use. |
| 105 | GGSN | Receives MBMS data to be provided to a UE, |
| | | directly from a Multicast/Broadcast source and |
| | | from a Multicast/Broadcast source via a BM-SC |
| | | or a BG, and transmits the received MBMS |
| | | data to an SGSN. Collects accounting information |
| | | of a UE, manages the movement of each |
| | | UE, and manages the QoS of an |
| | | MBMS service that the UE receives. |
| 106 | BM-SC | Authenticates a content provider, determines the |
| | | QoS of an MBMS service, performs error |
| | | correction on defective MBMS data, and provides |
| | | accounting information to the content provider. |
| | | Receives MBMS data from the content provider |
| | | and provides the MBMS data to a GGSN. |
| | | Notifies a UE of a current MBMS service. |
| 107 | Multicast/ | Directly provides MBMS data to a GGSN. |
| | Broadcast | |
| | Source | |
| 108 | BG | Receives MBMS data from a Multicast/Broadcast |
| | | source in a network that is not managed by the |
| | | current service provider, and transmits the MBMS |
| | | data to a GGSN. |
| 109 | Content | Provides MBMS contents to a BM-SC. |
| | Provider | |
| 110 | Multicast/ | Directly provides MBMS data to a GGSN. |
| | Broadcast | |
| | Source | |

The functions of the elements described in connection with Table 1 are subject to change according to a network operator, but the fundamental functions of each elements remain constant. A cell broadcast center (CBC) for providing prior information to a UE for a current MBMS service can be added to FIG. 1.

Table 2 below contains the definition of interfaces between the elements described in conjunction with Table 1.

TABLE 2

| Reference | | |
|---|---|---|
| Numeral | Name | Function |
| 121 | Uu | Interface between a UE and a UTRAN |
| 122 | Iu | Interface between a UTRAN and a CN |
| 123 | Gr | Interface between an SGSN and an HLR |
| 124 | Gn/Gp | Interface between an SGSN and a GGSN |
| 125 | Gi | Interface between a GGSN and a BM-SC |
| 126 | Gi | Interface between a GGSN and a Multicast/ |
| | | Broadcast source |
| 127 | Gi | Interface between a GGSN and a BG |
| 128 | Gn/Gp | Interface between a BM-SC and a contents provider |
| 129 | Gi | Interface between a BG and a Multicast/Broadcast |
| | | source |

Although names of the interfaces, defined in 3GPP, are used in Table 2, the names are subject to change.

In the mobile communication system, in order to provide an MBMS service, fundamental information for the MBMS service is delivered to UEs. Further, a list of UEs desiring to receive the MBMS service is delivered to a network. The network pages the UEs based on the list of the UEs. The paged UEs set up a radio bearer for providing the MBMS service. The MBMS service is provided over the set radio bearer. If the MBMS service is closed, information on the closed service is provided to all UEs receiving the MBMS service, as all the UEs must release all of the resources assigned for the MBMS service, in order to normally close the MBMS service.

In order to provide an MBMS service in this way, control messages must be exchanged between a network and the UEs. In order to transmit the control messages, a paging process from the network to the UEs should be preferentially performed.

A paging procedure for the MBMS service will now be described. In the paging procedure, a UiE periodically receives a paging indicator channel (PICH) signal transmitted from a Node B. The UE determines if a paging channel (PCH) signal is transmitted thereto through the received PICH signal. Information on the PICH is included in a system information block (SIB) of a broadcast channel (BCH). The UE can acquire information on the PICH by analyzing the BCH. The PICH information refers to information required for receiving the PICH signal.

The paging process refers to all processes in which a network pages a particular UE. In paging a UE, the network uses a discontinuous reception (DRX) scheme to minimize power consumption of the UE. In the DRX scheme, a UE sets a time (or occasion) when it turns on its receiver to receive a paging message, and receives a paging message only at the set time. The UE turns on its receiver only at a predetermined time, and turns off the receiver at other times except the set time. The UE receives a PICH signal on a paging occasion (PO), and receives a paging message transmitted over PCH when a corresponding paging indicator (PI) of the received PICH signal is set to ‘1’. In this manner, power consumption can be minimized in the paging process.

FIG. 2 is a diagram illustrating a process of receiving a PICH signal and a PCH signal by a UE. Specifically, FIG. 2 illustrates an occasion when a UE receives a PICH signal and a PCH signal where a UE DRX cycle length is 5.12 sec and PCH for MBMS paging is transmitted every 512 frames.

Referring to FIG. 2, a particular UE wakes up (i.e. turns on its receiver) at a corresponding PO time of a PICH radio frame transmitted at a time SFN2 and monitors the PI. The PI that the UE monitors is divided into PI indicating general PCH transmission and PI indicating PCH transmission for an MBMS service. The PIs indicating PCH transmission for an MBMS service are included in an unused part in an existing PICH signal. The UE demodulates the PI indicating transmission of a general PCH signal and MBMS PIs indicating transmission of a PCH signal for an MBMS service. For example, the UE determines that there is no general PCH transmission if the PI indicating general PCH transmission is demodulated into ‘1’. However, the UE determines that there is PCH transmission for MBMS paging if the demodulated MBMS PIs include information indicating a start of an MBMS service indicated by an identifier of an MBMS service the UE is to receive. Then the UE prepares to receive a PCH signal by paging an MBMS service.

If the PCH signal for paging an MBMS service has already been transmitted, the UE waits to receive a PCH signal. If there is enough time from a current time to a transmission time of a next PCH, the UE transitions to a sleep mode (i.e. turns off its receiver). The UE then wakes up at the time when the next PCH signal is transmitted, and receives the PCH signal.

In FIG. 2, a time when a next PI is to be monitored comes before a time where a next PCH signal is to be received. The UE holds a sleep mode until a time when the next PI is to be monitored. The UE demodulates a consecutively received PCH signal, if a demodulation result of the next PI is ‘1’. At this time, a general PCH signal is also demodulated.

However, in the DRX scheme, a network, or a Node B, must periodically transmit a PCH signal. In response, a UE also periodically analyzes the PIs at the PO of a PICH signal, and then receive a PCH signal associated thereto. Therefore, a load occurs on both the Node B and the UE.

### SUMMARY OF THE INVENTION

There is a demand for a paging procedure for allowing all UEs in a cell, intended to receive an MBMS service, to receive paging information, and for a procedure to efficiently transmit repeated MBMS paging information in a UTRAN.

It is, therefore, an object of the present invention to provide a method for efficiently paging UEs to provide an MBMS service in a mobile communication system.

It is another object of the present invention to provide a paging method in a mobile communication system supporting an MBMS service, wherein an MBMS paging control frame is newly defined.

It is further another object of the present invention to provide a method for simplifying signaling between a radio network controller and a Node B in transmitting paging information for an MBMS service.

It is yet another object of the present invention to provide a method for performing an MBMS paging procedure while a Node B does not transmit a response message to MBMS paging information provided from a radio network controller.

It is still another object of the present invention to provide a method for allowing transmission of a PICH signal based on new MBMS paging information even while transmitting from a radio network controller a PICH signal in response to MBMS paging information.

It is still another object of the present invention to provide a method for transmitting PICH by a Node B based on MBMS paging information transmitted through an MBMS paging control frame.

It is still another object of the present invention to provide a method for delivering MBMS paging information to a Node B through an MBMS paging control frame by a radio network controller.

It is still another object of the present invention to provide a method for transmitting a PICH by a Node B based on an MBMS paging control frame that is repeatedly transmitted from a radio network controller a predetermined number of times.

It is still another object of the present invention to provide a method for repeatedly transmitting, by a radio network controller, MBMS paging information through an MBMS paging frame a predetermined number of times.

It is still another object of the present invention to provide a paging method in a mobile communication system supporting an MBMS service, wherein a new control frame is used during communication from a radio network controller to a Node B.

It is still another object of the present invention to provide a method for including PCH transmission start time and repetition count in a new control frame before transmission during communication from a radio network controller to a Node B.

It is still another object of the present invention to provide a method capable of using a response message to a new control frame during communication from a radio network controller to a Node B.

It is still another object of the present invention to provide a method for repeatedly transmitting from a radio network controller to a Node B a new control frame a predetermined number of times during communication.

According to a first aspect of the present invention, there is provided a method for transmitting by a radio network controller (RNC) paging information for transmission of a paging indicator channel to a Node B in a mobile communication system including the RNC, at least one Node B connected to the RNC, and at least one user equipment (UE) receiving a broadcast service from the Node B, wherein the paging indicator channel indicating a start of the broadcast service is transmitted to the UE by the Node B. The method comprises the steps of generating a paging control frame based on the paging information including paring indicator bit mapping information indicating paging for each broadcast service; transmitting the paging control frame to the Node B; and receiving a response message to the paging control frame from the Node B.

According to a second aspect of the present invention, there is provided a method for transmitting by a radio network controller (RNC) paging information for transmission of a paging indicator channel to a Node B in a mobile communication system including the RNC, at least one Node B connected to the RNC, and at least one user equipment (UE) receiving a broadcast service from the Node B, wherein the paging indicator channel indicating a start of the broadcast service is transmitted to the UE by the Node B. The method comprises the steps of generating a paging control frame based on the paging information including paging indicator bit mapping information indicating paging for each broadcast service; and repeatedly transmitting the paging control frame to the Node B a predetermined number of times.

According to a third aspect of the present invention, there is provided a method for transmitting by a Node B a paging indicator channel indicating a start of a broadcast service to a user equipment (UE) in a mobile communication system including a radio network controller (RNC), at least one Node B connected to the RNC, and at least one UE receiving the broadcast service from the Node B. The method comprises the steps of receiving paging information including paging indicator bit mapping information indicating paging for each broadcast service, from the RNC through a paging control frame; transmitting a response message including the paging information to the RNC in response to the paging control frame; and transmitting the paging indicator channel to the UE based on the paging information.

According to a fourth aspect of the present invention, there is provided a method for transmitting by a Node B a paging indicator channel indicating a start of a broadcast service to a user equipment (UE) in a mobile communication system including a radio network controller (RNC), at least one Node B connected to the RNC, and at least one UE receiving the broadcast service from the Node B. The method comprises the steps of receiving paging information including paging indicator bit mapping information indicating paging for each broadcast service, through a paging control frame that is repeatedly transmitted from the RNC a predetermined number of times; transmitting the paging indicator channel to the UE based on the repeatedly transmitted paging information; and if the repeatedly transmitted paging information is changed, transmitting the paging indicator channel to the UE based on the changed paging information.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a general mobile communication network supporting an MBMS service;

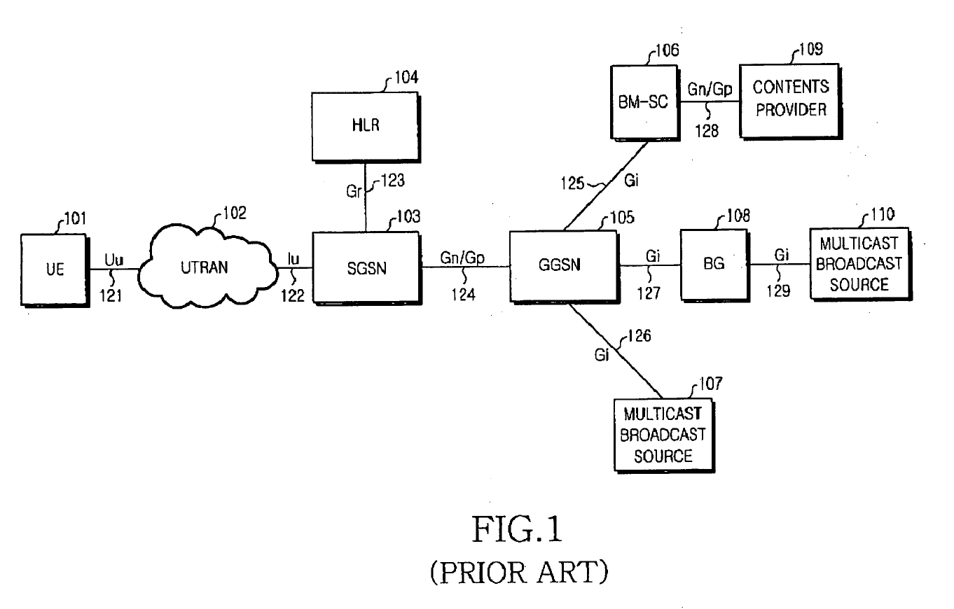

FIG. 2 is a diagram illustrating reception points of PICH and PCH in a general mobile communication system;

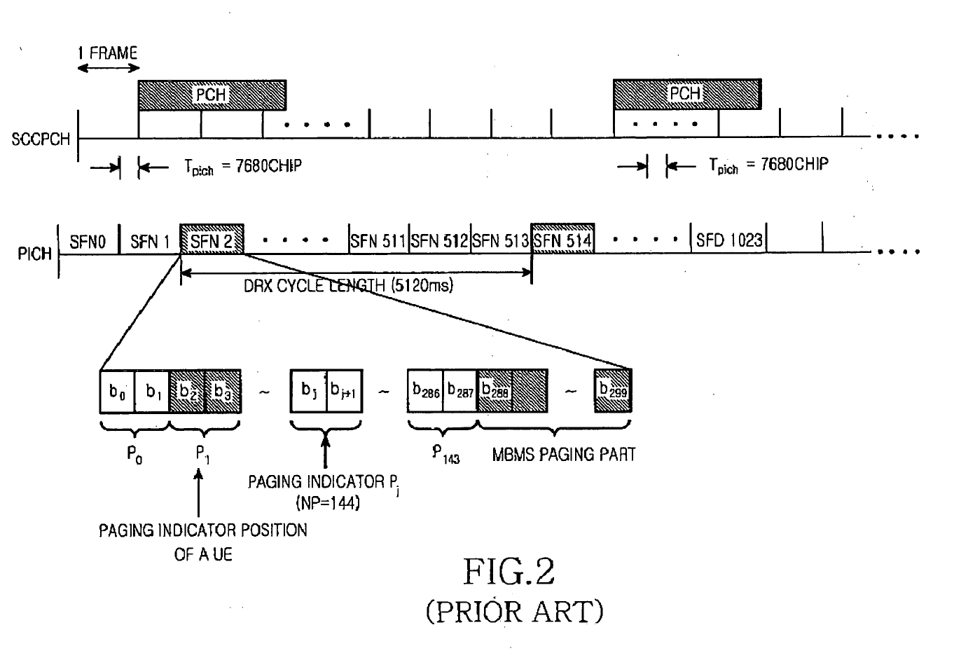

FIG. 3 is a diagram illustrating a format of an MBMS paging control frame according to an embodiment of the present invention;

FIG. 4 is a diagram illustrating a signaling procedure for transmitting MBMS paging information in a mobile communication network according to a first embodiment of the present invention;

FIG. 5 is a diagram illustrating a signaling procedure for transmitting MBMS paging information in a mobile communication network according to a second embodiment of the present invention;

FIG. 6 is a flowchart illustrating an operating procedure of an RNC according to the first embodiment of the present invention;

FIG. 7 is a flowchart illustrating an operating procedure of a Node B according to the first embodiment of the present invention;

FIG. 8 is a flowchart illustrating an operating procedure of an RNC according to the second embodiment of the present invention;

FIG. 9 is a flowchart illustrating an operating procedure of a Node B according to the second embodiment of the present invention; and

FIG. 10 is a flowchart illustrating an operating procedure of a UE according to the first and second embodiments of the present invention.

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

In the following description, several typical embodiments of the present invention for achieving the above and other objects will be presented. In addition, the messages and signaling used herein are well described in 3GPP TS 25.331.

The present invention proposes a paging method for minimizing power consumption of a UE by a network, or a UTRAN, in a mobile communication system supporting an MBMS service. The paging methods proposed wherein can be applied even though the UE is in any one of an IDLE state, a CELL_PCH state or a URA_PCH state. The states of the UE will be described below.

(1) CELL_PCH state: A UE in a CELL_PCH state monitors PICH, and does not receive other channels, such as a forward access channel (FACH). A radio network controller (RNC) must page a UE and cause the UE to transition to a CELL_FACH state, before transmitting data to the UE. Likewise, the UE must transition to the CELL_FACH state before transmitting data to the RNC. The RNC searches for a position of the UE on a cell-by-cell basis. In the paging procedure, a DRX parameter determined by the RNC is used.

(2) URA_PCH state: identical to the CELL_PCH state except that the RNC searches for a position of the UE on a UTRAN Registration Area (URA; an area comprised of multiple cells)-by-URA basis.

(3) IDLE state: In this state, the RNC can not ascertain the position of the UE, and can page the UE at the request of a CN. The paging procedure in this state is identical to the paging procedure in the CELL_PCH state except that a DRX parameter determined in the CN is used. In order to exchange data between the RNC and the UE, a radio resource control (RRC) connection setup procedure should be preferentially performed.

The present invention proposes a method for determining MBMS paging transmission control information where on a transmission time of a PICH signal is further determined, and a method for transmitting a PICH signal based on the MBMS paging transmission control information. As the method for transmitting a PICH signal, a signaling procedure for forming a message for transmitting a MBMS paging message, and transmitting a PICH signal based on the MBMS paging information will be described in detail. In addition, an operation performed for the signaling procedure in each element of a mobile communication network will be described in detail.

A definition of the terms used herein will be given herein below.

MBMS paging transmission control information: Information for determining a time when a Node B transmits a PICH signal and a time when a UE receives a PICH signal. For example, this information is comprised of a transmission interval (hereinafter referred to as “PAGING_INTERVAL”) for which a PCH signal is transmitted for each MBMS service, and information (hereinafter referred to as “OFFSET”) indicating a transmission start position. The PAGING_INTERVAL and the OFFSET are not unconditionally, periodically determined, but adaptively determined by an SGSN or an RNC according to circumstances.

MBMS paging information: Information required by a Node B to transmit a PICH signal for each MBMS service.

### A. Determination of MBMS Paging Transmission Control Information

Commonly, in the case of an MBMS service, a plurality of UEs receive service notification paging information needed to receive the MBMS service. In this case, all of the UEs cannot receive the paging information in the same location. Therefore, it is preferable to periodically and repeatedly transmit paging information and set a different offsets for each UE so that the UEs can reliably receive the paging information. Thus, in the following description of the present invention, the MBMS paging transmission control information includes an interval PAGING_INTERVAL during which a PCH signal is transmitted and information OFFSET indicating its transmission start time.

A description will now be made of a method for determining the MBMS paging transmission control information according to an embodiment of the present invention.

A method for determining the MBMS paging transmission control information can be divided into two methods: one for determining MBMS paging transmission control information by an SGSN and another for determining MBMS paging transmission control information by an RNC.

First, a description will be made of the method for determining PAGING_INTERVAL and OFFSET, on which the time to transmit/receive a PCH signal is determined, by an SGSN.

An SGSN determines PAGING_INTERVAL and OFFSET for each MBMS service or each routing area (RA). The PAGING_INTERVAL and the OFFSET can be defined as a function of a temporary multicast group identity (TMGI). Alternatively, the PAGING_INTERVAL and the OFFSET can be fixed at their predetermined values for each MBMS service. Here, the TMGI is a kind of an identifier for identifying an MBMS service. Therefore, a unique TMGI is assigned to each MBMS service. The TMGI is assigned at the time where an MBMS service context for a particular MBMS service is first generated, and the TMGI is released when the corresponding MBMS service is closed. There is no specific rule for the TMGI assignment. However, it is general rule that in the same SGSN, a unique TMGI value is assigned to a particular MBMS service.

The PO calculated by the SGSN based on PAGING_INTERVAL and OFFSET is defined by:

SFN(PO)=TMGI_{—}K mod PAGING_INTERVAL+n*PAGING_INTERVAL (1)

In Equation (1), n=integer (1, 2, 3, . . . ), and SFN(PO) is smaller than 4095 (SFN(PO)<4095). The SFN (System Frame Number) is an integer that repeatedly increases between 0 and 4095, and is frame timing information counted by a Node B. TMGI_K is TMGI div K (TMGI_K=TMGI div K). A parameter K used for calculating the TMGI_K indicates the number of secondary common control physical channels (S-CCPCHs)/PCHs which are set up to a corresponding cell. The S-CCPCH/PCH indicates S-CCPCH which is a physical channel to which PCH is mapped. The PAGING_INTERVAL is 2PAGING_INTERVAL_COEFF, and the PAGING_INTERVAL_COEFF is a parameter having an integer value of between 0 to 9. The PAGING_INTERVAL is determined based on a value of the PAGING_INTERVAL_COEFF.

As shown in Equation (1), PO is a set of SFNs which are repeated at periods of MBMS transmission interval PAGING_INTERVAL. Further, in Equation (1), TMGI_K mod PAGING_INTERVAL is provided to uniquely set OFFSET for each TMGI (or each MBMS service).

The OFFSET can also be set to a predetermined value. If the OFFSET is set to a predetermined value, the predetermined value must be sent to a UE together with the PAGING_INTERVAL.

The PAGING_INTERVAL and the OFFSET determined by the SGSN in the method stated above are delivered to a UE and a Node B in a predetermined signaling procedure. That is, the SGSN includes the PAGING_INTERVAL and the OFFSET in an MBMS Service Response message corresponding to an MBMS Service Activation Request message from a UE, and transmits the MBMS Service Response message to the UE. Then the UE checks the PI included in a PICH signal every PO that is determined based on the PAGING_INTERVAL and the OFFSET. The PI is for an MBMS service. The PI for an MBMS service is transmitted using an unused part in the PICH signal.

Second, a description will be made of a method for determining PAGING_INTERVAL and OFFSET, upon which a time to transmit/receive a PCH signal is determined, by an RNC.

An RNC determines PAGING_INTERVAL and OFFSET for each cell according to load and channel conditions of a UTRAN. The RNC, like the SGSN, can define the PAGING_INTERVAL and the OFFSET as a function of TMGI, or set the PAGING_INTERVAL and the OFFSET to their predetermined values for each MBMS service.

As stated above, the PAGING_INTERVAL and the OFFSET determine by the RNC are delivered to a UE and a Node B in a predetermined procedure. That is, the PAGING_INTERVAL and the OFFSET determined for each cell according to the load and channel conditions of a UTRAN are delivered to a UE as a broadcast channel (BCH) or FACH over a broadcast control channel (BCCH). Then the UE perceives the PAGING_INTERVAL and the OFFSET. Meanwhile, when the PAGING_INTERVAL and the OFFSET are changed, the RNC delivers the changed PAGING_INTERVAL and OFFSET to the UE. In this case, the UE perceives the changed PAGING_INTERVAL and OFFSET.

Meanwhile, the RNC informs a Node B of the PAGING_INTERVAL and the OFFSET through a frame protocol, and the Node B transmits a PCH signal to UEs according to the PAGING_INTERVAL and the OFFSET. This process will be described below.

In order to support transmission of a PICH signal, a method for delivering MBMS paging information from an RNC to a Node B should be newly defined. Therefore, the present invention proposes a method for transmitting, by an RNC, MBMS paging information for several MBMS services to a Node B through a control frame. This is an exemplary method for forming a PICH signal for each MBMS service and transmitting the PICH signal.

A description will now be made of a method for transmitting MBMS paging information using a control frame of an IuB frame protocol according to an embodiment of the present invention.

### B. MBMS Paging Control Frame Format

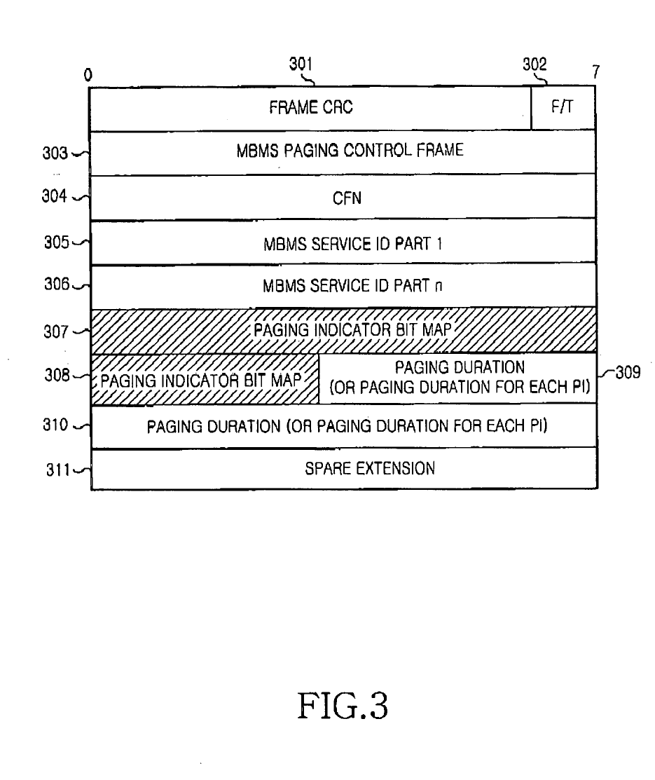

FIG. 3 is a diagram illustrating an MBMS paging control frame proposed in the present invention. A format of the MBMS paging control frame illustrated in FIG. 3 is constructed by adding information to a fundamental format of a general IuB control frame.

Referring to FIG. 3, reference numeral 301 denotes a field for transmitting a cyclic redundancy code (CRC) used for error check on a control frame, and the field 301 has a 7-bit length. Reference numeral 302 denotes a field for transmitting frame type (F/T) information indication whether a corresponding frame is a data frame or a control frame, and the field 302 has a 1-bit length. Reference numeral 303 denotes a field indicating a type of a control frame, and field 303 has an 8-bit length. In an embodiment of the present invention, information indicating an MBMS paging control frame is set in the field 303. Reference numeral 304 denotes a field for transmitting the connection frame number (CFN) information indicating a time when the content of the control frame comes into effect, and a basic unit thereof is a 10-ms radio frame. Reference numerals 305 and 306 denote fields through which MBMS service ID information representing an MBMS service indicated by the MBMS paging control frame. There are several fields through which the MBMS service ID information is transmitted. The length of the MBMS service ID information is not stipulated yet. The MBMS service ID should necessarily be used in order to distinguish MBMS paging information when several MBMS services are provided or paging information for another MBMS service is transmitted after paging information for a particular MBMS service is transmitted. However, if paging information for only one MBMS service is transmitted, the MBMS service ID may not be transmitted. Use of the MBMS service ID can depend upon operator's network application.

Reference numerals 307 and 308 denote fields through which MBMS paging indicator bit mapping information is transmitted. The MBMS paging indicator bit mapping information is information indicating whether to page each of the MBMS services. As defined above, the unused part of the PICH over which the MBMS paging information is transmitted has a 12-bit length. The MBMS paging indicator bit mapping information can be transmitted through the fields indicated by reference numerals 307 and 308.

The MBMS paging control frame proposed in the present invention can optionally have a paging duration value. Reference numerals 309 and 310 denote fields in which the paging duration value is transmitted. The paging duration value is included in an MBMS paging control frame, and used for setting the transmission duration of a paging indicator indicating an MBMS service in the PICH. Further, the paging duration value is used for setting the transmission duration for each of the paging indicators indicating different MBMS services.

When PICH transmission duration is set up for each frame, an RNC transmitting the MBMS paging control frame can transmit an MBMS paging control frame having new contents after transmission duration of the MBMS paging control frame. This is because the PI indicting an MBMS service in the PICH based on previously transmitted MBMS paging information should be sufficiently transmitted, in order for UEs intended to receive an MBMS service corresponding to the MBMS paging information to sufficiently receive paging information. Alternatively, in order to page another MBMS service while paging a particular MBMS service, the transmission duration is individually necessary for each paging indicator. This is because the contents of the paging can be changed in order for another service to be started, while a paging operation for the transmitting of the control information for a particular MBMS services to UEs desiring to receive the MBMS services is performed. In order to simultaneously and efficiently perform paging for the transmission of the control information on the MBMS services and paging on the other MBMS services, the paging duration can be individually used for each PI proposed in the present invention. Reference numeral 311 denotes a spare extension field for added functions, and if there are no added functions, the field 311 is not used.

### C. EMBODIMENTS

An MBMS paging control frame proposed in the present invention is used to instruct Node Bs to transmit MBMS paging information indicting an MBMS service in the same PICH for a predetermined duration. If Node Bs receive a defective MBMS paging control frame due to an error, the Node Bs transmit a defective PICH signal for the corresponding duration. As a result, UEs receiving the PICH signal also perform a misoperation. In order to prevent the misoperation, it is necessary to prevent a PICH signal from being transmitted by the defective MBMS paging control frame.

In the PICH transmission for a general voice signal, an RNC transmits the contents of the PICH to a Node B at every time interval because paging information is changed for a voice call every 10 msec. However, group paging is used for the MBMS service, and because the PICH including the paging information having the same contents is repeatedly transmitted for a predetermined duration, the paging information is not required to be transmitted from the RNC to the Node B at every time interval. When the Node B receives a defective MBMS paging control frame, the above-stated problem may occur. The present invention proposes a method of using a response message or a method of repeatedly transmitting an MBMS paging control frame.

### 1. First Embodiment

A first embodiment of the present invention proposes a method of using a response message to an MBMS paging control frame. In this method, a Node B receiving an MBMS paging control frame from an RNC transmits a response message so that the RNC can determine if an error has occurred in the MBMS paging control frame.

The first embodiment of the present invention will now be described in detail with reference to the accompanying drawings.

### 1.1 Signaling

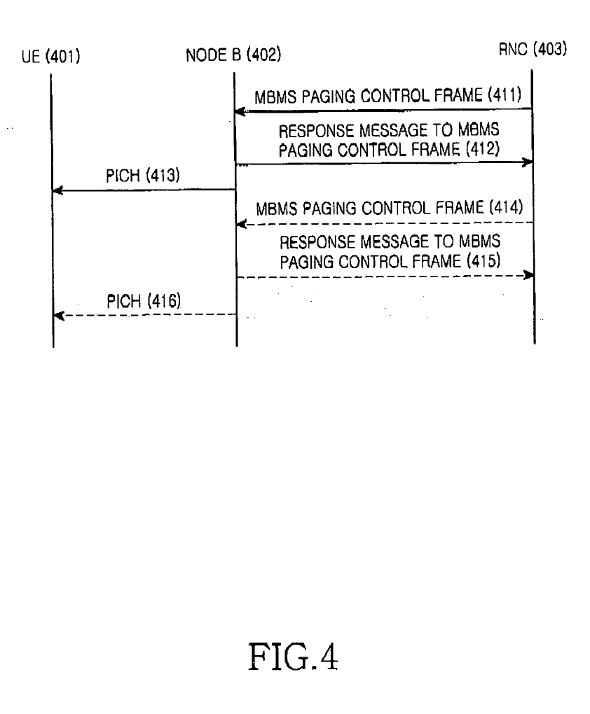

FIG. 4 is a diagram illustrating a signaling procedure for using a response message to an MBMS paging control frame according to the first embodiment of the present invention. For use in the following example, it is assumed in FIG. 4 that one UE 401, one Node B 402, and one RNC 403 are used. However, application of the present invention is not restricted to any number of UEs and Node Bs.

Referring to FIG. 4, the RNC 403 transmits the MBMS paging information to the Node B 402 through an MBMS paging control frame in step 411. The MBMS paging control frame has a format described in conjunction with FIG. 3. The Node B 402 receives the MBMS paging control frame from the RNC 403. The Node B 402 transmits a response message to the RNC 403 in step 412 to indicate if the MBMS paging control frame has been correctly received. The response message transmitted from the Node B 402 to the RNC 403 includes the intact contents of the MBMS paging control frame.

The Node B 402 determines if another MBMS paging control frame is received from the RNC 403 during a predetermined PICH transmission time. If another MBMS paging control frame is not received from the RNC 403 during the PICH transmission time, the Node B 402 transmits a PICH signal to the UE 401 in step 413. The PICH signal is transmitted for a paging duration set in the MBMS paging control frame. Transmission of the PICH signal is performed based on MBMS paging information acquired through the MBMS paging control frame.

The Node B 402 determines if a new MBMS paging control frame is received from the RNC 403 during the paging duration for which the PICH signal is transmitted. The new MBMS paging control frame being received from the RNC 403 is equivalent to the occurrence of a new event. The event can include a situation where an RNC has detected that there was an error in the contents of the previously transmitted MBMS paging control frame, or a situation where paging for another MBMS service is necessary. If the event occurs, the RNC 403 transmits a new MBMS paging control frame to the Node B 402 in step 414. Upon receiving the new MBMS paging control frame, the Node B 402 transmits a response message thereto to the RNC 403 in step 415. In step 416, the Node B 402 transmits a PICH signal to the UE 401 based on the MBMS paging information included in the received new MBMS paging control frame.

In the first embodiment, when there is no more MBMS paging information to transmit, an RNC inserts all 0s in a PI bit map part of the MBMS paging control frame before transmission in order to inform the Node Bs that there is no UE to be paged. Node Bs receiving the MBMS paging control frame determine that there is no more paging for an MBMS service, and do not transmit an unused part of the PICH or transmit a value of all 0s. The reason for transmitting the value of all 0s is to reduce a peak to average power ratio (PAPR) of a radio frequency.

### 1.2 Operation of RNC

According to the first embodiment of the present invention, an RNC generates an MBMS paging control frame including MBMS paging information, transmits the generated MBMS paging control frame to a Node B, and analyzes a response message received in response to the MBMS paging control frame to determine if an error has occurred in the MBMS paging control frame. If it is determined that an error has occurred, the RNC re-generates an MBMS paging control frame and transmits the MBMS paging control frame to the Node B. However, if the new paging occurs, the RNC generates an MBMS paging control frame in which the new paging is reflected, and transmits the generated MBMS paging control frame to the Node B.

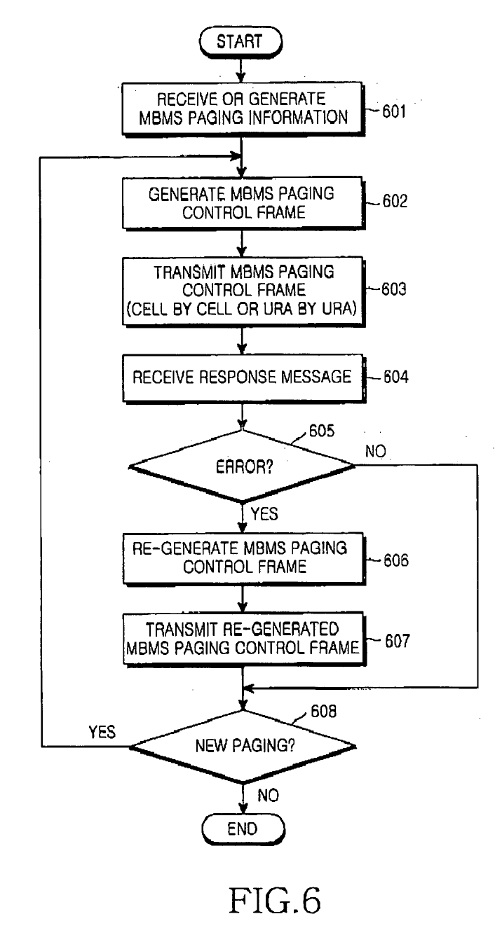

FIG. 6 is a flowchart illustrating an operating procedure of an RNC according to the first embodiment of the present invention. In a description of FIG. 6, it is assumed that the format of the MBMS paging control frame shown in FIG. 3 is used.

Referring to FIG. 6, an RNC receives the MBMS paging information from an SGSN or generates the MBMS paging information in step 601. The MBMS paging information can include a paging offset, an MBMS service ID, and an MBMS paging duration.

In step 602, the RNC generates an MBMS paging control frame including the MBMS paging information. In step 603, the RNC transmits the MBMS paging control frame. The MBMS paging control frame is transmitted to all Node Bs that will provide an MBMS service corresponding to the MBMS paging information. The RNC can transmit the MBMS paging control frame on a cell-by-cell basis or URA-by-URA basis. For example, the RNC transmits an MBMS paging control frame including the MBMS paging information from an SGSM on an URA-by-URA basis, and transmits an MBMS paging control frame including the MBMS control information generated by the RNC itself on a cell-by-cell basis.

In step 604, the RNC receives from the Node Bs response messages to the MBMS paging control frame. In step 605, the RNC determines if the contents of the response message are equal to the contents of the MBMS paging control frame. This is done to determine if there is any Node B that has received a defective MBMS paging control frame. If the contents of the MBMS paging control frame are not identical to the contents of the response message, the RNC considers that a Node B that transmitted the response message has received a defective MBMS paging control frame. If it is determined that an error has occurred in an MBMS paging control frame received by a particular Node B, the RNC re-creates an MBMS paging control frame in step 606. In step 607, the RNC transmits the re-generated MBMS paging control frame.

After step 605 or 607, the RNC determines in step 608 if a new paging is to occur. If new paging occurs, the RNC returns to step 602 and repeats a process of generating the MBMS paging control frame and transmitting the generated MBMS paging control frame.

A method for repeatedly performing a procedure for transmitting the MBMS paging control frame can be divided into the following two methods.

In a first method, an MBMS paging control frame in which a new paging is reflected is transmitted after waiting until the paging based on a previously transmitted MBMS paging control frame has ended even though the new paging has occurred.

In a second method, a transmission duration is set for each PI corresponding to each MBMS service. The second method is advantageous in that there is no time delay in transmitting a new PICH signal, but it is disadvantageous in that the contents of the MBMS paging control frame is somewhat complex.

### 1.3 Operation of Node B

According to the first embodiment of the present invention, a Node B receives an MBMS paging control frame including the MBMS paging information from an RNC, and transmits a response message to the MBMS paging control frame to the RNC. Thereafter, the Node B transmits a PICH signal indicating the paging for each MBMS service based on the MBMS paging information. If a new MBMS paging control frame is received from the RNC due to generation of the new paging information, the Node B transmits a PICH signal based on the new MBMS paging information.

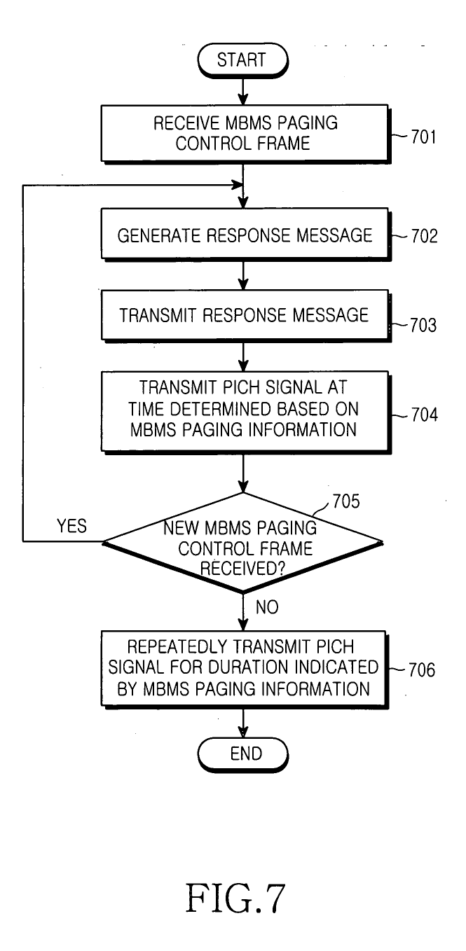

FIG. 7 is a flowchart illustrating an operating procedure of a Node B for implementing the first method proposed in FIG. 4. In a description of FIG. 7, it is assumed that the format of the MBMS paging control frame shown in FIG. 3 is used.

FIG. 7 is a flowchart illustrating an operating procedure of a Node B corresponding to the operating procedure of the RNC described in connection with FIG. 6.

Referring to FIG. 7, a Node B receives an MBMS paging control frame in step 701. [Please delete this description because the Node B is not able to analyzes whether the MBMS paging information coincides with a desired MBMS service.

In step 702, the Node B generates a response message to the received MBMS paging control frame. The response message is generated such that it has the MBMS paging information included in the MBMS paging control frame. In step 703, the Node B transmits the response message. The response message will be received at an RNC that transmitted the MBMS paging control frame. The Node B analyzes MBMS paging information included in the received MBMS paging control frame. Thereafter, in step 704, the Node B starts the transmission of a PICH signal at a transmission time indicated by the analyzed MBMS paging information.

In step 705, the Node B determines if a new MBMS paging control frame is received from the RNC. If it is determined that a new MBMS paging control frame is received, the Node B returns to step 702 and performs again the procedure stated above. However, if it is determined that a new MBMS paging control frame is not received, the Node B proceeds to step 706. In step 706, the Node B repeatedly transmits the paging information indicating an MBMS service designated in the PICH for a transmission duration indicated by the MBMS paging information.

### 2. Second Embodiment

A second embodiment of the present invention proposes a method of repeatedly transmitting an MBMS paging control frame a predetermined number of times, instead of using a response message. Because an MBMS paging control frame from an RNC is repeatedly transmitted a predetermined number of times, a Node B can determine if an error has occurred in the MBMS paging control frame.

The second embodiment of the present invention will now be described in detail with reference to the accompanying drawings.

### 2.1 Signaling

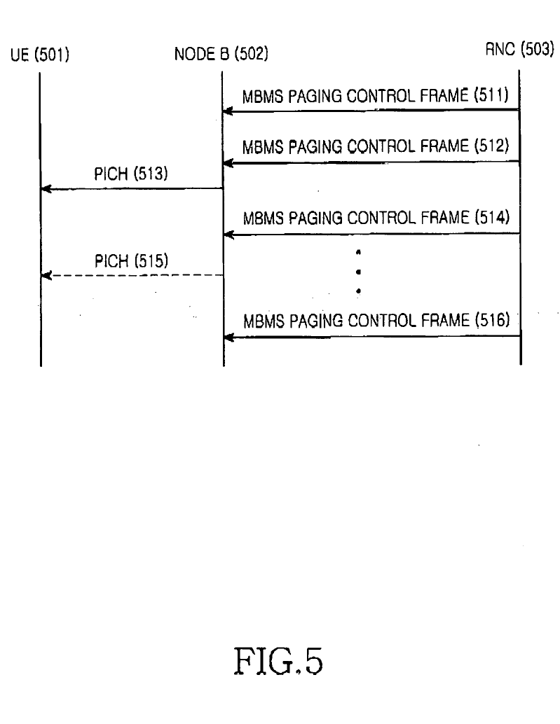

FIG. 5 is a diagram illustrating a signaling procedure for repeatedly transmitting an MBMS paging control frame without using a response message to the MBMS paging control frame according to the second embodiment of the present invention. The MBMS paging control frame is re-transmitted n times. A value of the ‘n’ is determined by an RNC and used only in the RNC, or is notified to a Node B. If an error occurs a predetermined number of times during n transmissions, the Node B determines the contents and a transmission time of the PICH. For the convenience of explanation, it is assumed in FIG. 5 that one UE 501, one Node B 502, and one RNC 503 are used. However, application of the present invention is not restricted to any number of UEs and Node Bs.

Referring to FIG. 5, the RNC 503 transmits an MBMS paging control frame n times in steps 511 to 516. The MBMS paging control frame can have a format described in conjunction with FIG. 3. The Node B 502 desiring to start an MBMS service corresponding to the MBMS paging control frame receives the MBMS paging control frame from the RNC 503 n times. The Node B 502 transmits a PICH signal to the UE 501 based on MBMS paging information included in the MBMS paging control frame. The Node B 502 can transmit the PICH signal after it receives the MBMS paging control frame n times or while it is receiving the MBMS paging control frames. When the Node B 502 transmits the PICH signal while it is receiving the MBMS paging control frames, a transmission time of the PICH signal indicated by the MBMS paging control frame comes ahead of a time where the Node B 502 receives an nth MBMS paging control frame. In step 513, it is assumed that a PICH signal is transmitted before an nth MBMS paging control frame is received.

If no error occurs in the MBMS paging control frame and a new MBMS paging information is not generated, MBMS paging control frames having the same MBMS paging information will be transmitted n times. However, in some cases, an error occurs in the MBMS paging control frame or the MBMS paging information is changed. In this case, the PICH signal should be transmitted such that the changed situation is immediately applied. If MBMS paging information is changed before transmission of the PICH signal in step 513, the changed MBMS paging information should be applied to the transmission of the PICH signal in step 513. In this case, the RNC 503 transmits an MBMS paging control frame having the changed MBMS paging information in step 512. However, if the MBMS paging information is changed after step 513, the changed MBMS paging information is applied in step 515 where the next PICH signal is transmitted. The RNC 503 transmits in step 514 an MBMS paging control frame having the changed MBMS paging information. In step 516, an nth MBMS paging control frame is transmitted.

Compared with the method proposed in FIG. 4, the method proposed in FIG. 5 is advantageous in that a response message of a Node B is not necessary and the MBMS paging information received from an RNC can be reflected in a real-time basis. However, compared with the method proposed in FIG. 4, the method proposed in FIG. 5 is disadvantageous in that an MBMS paging control frame having the same contents should be repeatedly transmitted.

In the second embodiment, when there is no more MBMS paging information to transmit, an RNC inserts all 0s in a PI bit map part of the MBMS paging control frame before the transmission in order to inform the Node Bs that there is no UE to be paged. The Node Bs receiving the MBMS paging control frame determine that there is no more paging for an MBMS service, and do not transmit an unused part of PICH or transmit a value of all 0s. The reason for transmitting the value of all 0s is to reduce a peak to average power ratio (PAPR) of a radio frequency.

### 2.2 Operation of RNC

According to the second embodiment of the present invention, an RNC generates an MBMS paging control frame including MBMS paging information, and repeatedly transmits the generated MBMS paging control frame to a Node B for a predetermined number of times. If new paging occurs while transmitting the MBMS paging control frame, the RNC generates a new MBMS paging control frame in which the new paging is reflected, and transmits the new MBMS paging control frame to the Node B. Although the new MBMS paging control frame is generated, the RNC can transmit the new MBMS paging control frame after waiting until the repeated transmission of the previous MBMS paging control frame is completed.

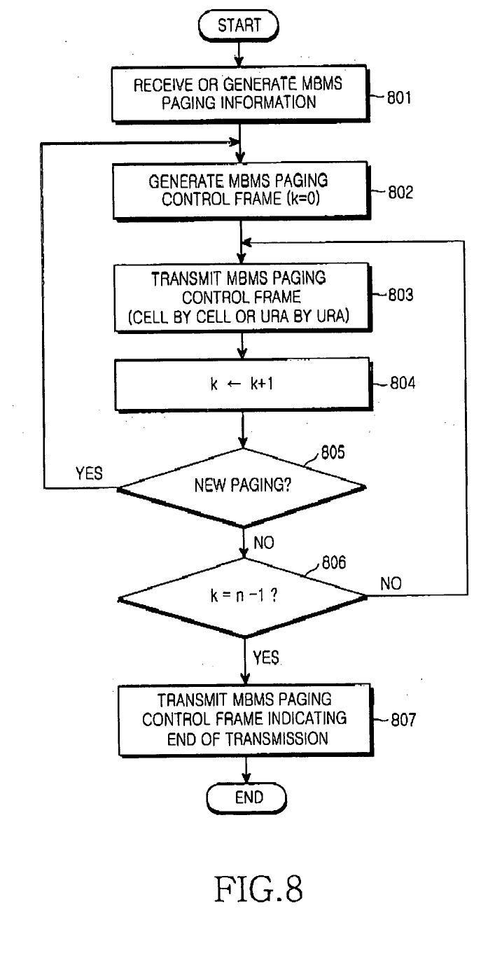

FIG. 8 is a flowchart illustrating an operating procedure of an RNC according to the second embodiment of the present invention proposed in FIG. 5. It is assumed in FIG. 8 that information on a paging duration is not used in the format of the MBMS paging control frame shown in FIG. 3. Instead of not using the paging duration information, a transmission end time of PICH is determined based on paging bit map information. For example, if a specific pattern (e.g., a pattern having all 0s) is transmitted as the paging bit map information, the transmission of PICH is ended. Other information except the paging duration information, in the information constituting the MBMS paging control frame, is used as is.

Referring to FIG. 8, an RNC receives MBMS paging information from an SGSN or generates MBMS paging information in step 801. The MBMS paging information can include a paging offset and an MBMS service ID.

In step 802, the RNC generates an MBMS paging control frame excluding the paging duration from the format shown in FIG. 3. Further, the RNC sets a count value k, for repeatedly transmitting the MBMS paging control frame a predetermined number of times, to ‘0’.

In step 803, the RNC transmits the MBMS paging control frame. The MBMS paging control frame is transmitted to all of the Node Bs that will provide an MBMS service corresponding to the MBMS paging information. The RNC can transmit the MBMS paging control frame on a cell-by-cell basis or URA-by-URA basis. For example, the RNC transmits an MBMS paging control frame including the MBMS paging information received from an SGSM on an URA-by-URA basis, and transmits an MBMS paging control frame including the MBMS control information generated by the RNC itself on a cell-by-cell basis.

In step 804, the RNC increases k, for counting a transmission count of the MBMS paging control frame, by 1, and then monitors in step 805 if new paging is to occur. If new paging occurs, the RNC returns to step 802 where it generates an MBMS paging control frame corresponding to the newly occurred paging. In step 803, the RNC transmits the generated MBMS paging control frame.

The new MBMS paging control frame can be generated before the MBMS paging control frame is transmitted n times. The RNC can perform the following two operations in transmitting the newly generated MBMS paging control frame. In a first operation, the RNC transmits a new MBMS paging control frame after the previous MBMS paging control frame is transmitted n times. In a second operation, the RNC transmits a new MBMS paging control frame before the previous MBMS paging control frame is transmitted n times. In the following description, the first operation is employed. However, the second operation can also be applied to the embodiment of the present invention. In case of the first operation, even though occurrence of new paging is detected, the RNC waits until the repeated transmission on the current MBMS paging control frame is completed. When the repeated transmission is completed, the RNC generates an MBMS paging control frame in which the newly occurred paging is reflected, and repeatedly transmits the generated MBMS paging control frame.

However, if no new paging has occurred, the RNC determines in step 806 if the MBMS paging control frame has been repeatedly transmitted n times. The determination is performed by determining if k has reached n−1. That is, if k is equal to n−1 (k=n−1), it is determined that the MBMS paging control frame has been transmitted n times. If the repeated transmission of the MBMS paging control frame is completed, the RNC proceeds to step 807 where it transmits an MBMS paging control frame in which paging bit map information is set to a particular pattern indicating completed transmission of an MBMS paging control frame.

Otherwise, if the repeated transmission on the MBMS paging control frame is not completed, the RNC returns to step 803 where it continues transmission of the MBMS paging control frame. However, if it is determined in step 805 that new paging has occurred, the RNC returns to step 802 where it generates an MBMS paging control frame in which the newly generated paging is reflected, and transmits the generated MBMS paging control frame n times.

### 2.3 Operation of Node B

According to the second embodiment of the present invention, a Node B receives an MBMS paging information from an RNC through an MBMS paging control frame that is transmitted at predetermined periods, and transmits a PICH signal indicting paging for each MBMS service based on the MBMS paging information. However, if changed MBMS paging information is received through the MBMS paging control frame, the Node B transmits the PICH signal based on the new MBMS paging information.

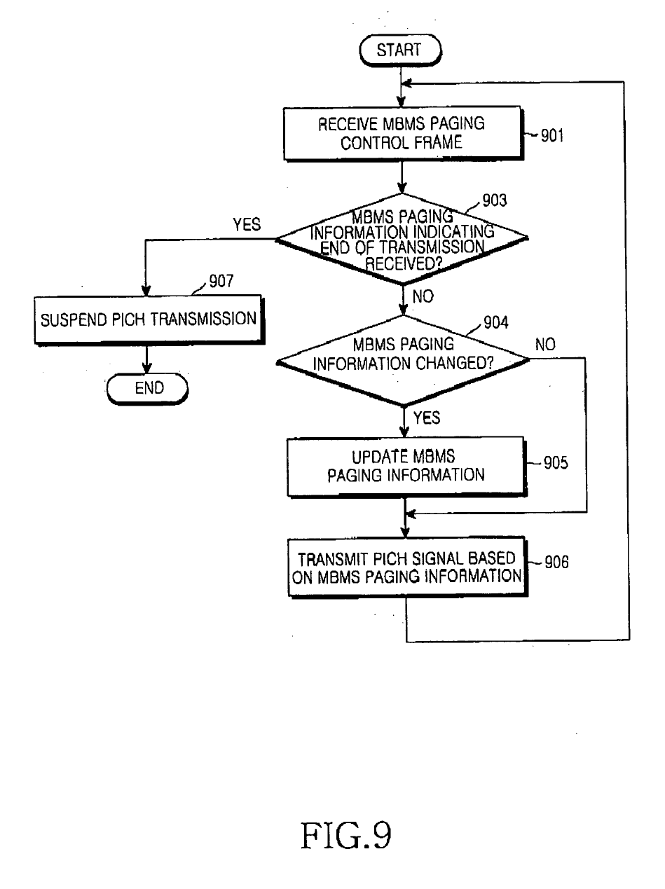

FIG. 9 is a flowchart illustrating an operating procedure of a Node B corresponding to the operating procedure of the RNC described in connection with FIG. 8. It is assumed in FIG. 9 that the information related to the paging duration is not used in the format of the MBMS paging control frame shown in FIG. 3. Instead of not using the paging duration information, a transmission end time of PICH is determined based on the paging bit map information. For example, if a specific pattern (e.g., a pattern having all 0s) is transmitted as the paging bit map information, the transmission of the PICH is ended. Other information except the paging duration information, in the information constituting the MBMS paging control frame, is used as is.

Referring to FIG. 9, in step 901, a Node B receives an MBMS paging control frame. In step 903, the Node B determines if the received MBMS paging information includes a predetermined pattern indicating the completed transmission thereof or includes paging bit map information. This is to monitor if the completed transmission of the MBMS paging control frame is notified. If the Node B fails to detect completed transmission of the MBMS paging control frame, it proceeds to step 904.

In step 904, the Node B monitors if a new MBMS paging information is received through the MBMS paging control frame. If no new MBMS paging information is received, the Node B proceeds to step 906. Otherwise, if a new MBMS paging information is received, the Node B updates the previous MBMS paging information with the new MBMS paging information in step 905, and then proceeds to step 906.

In step 906, the Node B starts the transmission of a PICH signal based on the MBMS paging information. The Node B transmits a PICH signal based on the same MBMS paging information if the new MBMS paging information is not received from the RNC before an n^{th} MBMS paging control frame is received. However, the Node B transmits the PICH signal based on the new MBMS paging information if the new MBMS paging information is received from the RNC before the nth MBMS paging control frame is received. The Node B will transmit the PICH signal based on the same MBMS paging information until the MBMS paging information is updated in step 905.

Although not illustrated in FIG. 9, even though MBMS paging information changes, an MBMS paging control frame in which new MBMS paging information is reflected can be transmitted after the MBMS paging control frame is repeatedly transmitted n times. In this case, the Node B can omit the operation of monitoring if the MBMS paging information is changed and transmitting the PICH signal according to the monitoring result. In some cases, after starting transmission of the PICH signal, the Node B receives a new MBMS paging control frame from the RNC before completed transmission of the MBMS paging control frame is detected. In this case, the Node B can start transmission of the PICH signal based on new MBMS paging control frame after transmission of the existing PICH signal is fully completed.

### 3. Operation of UE in First and Second Embodiments

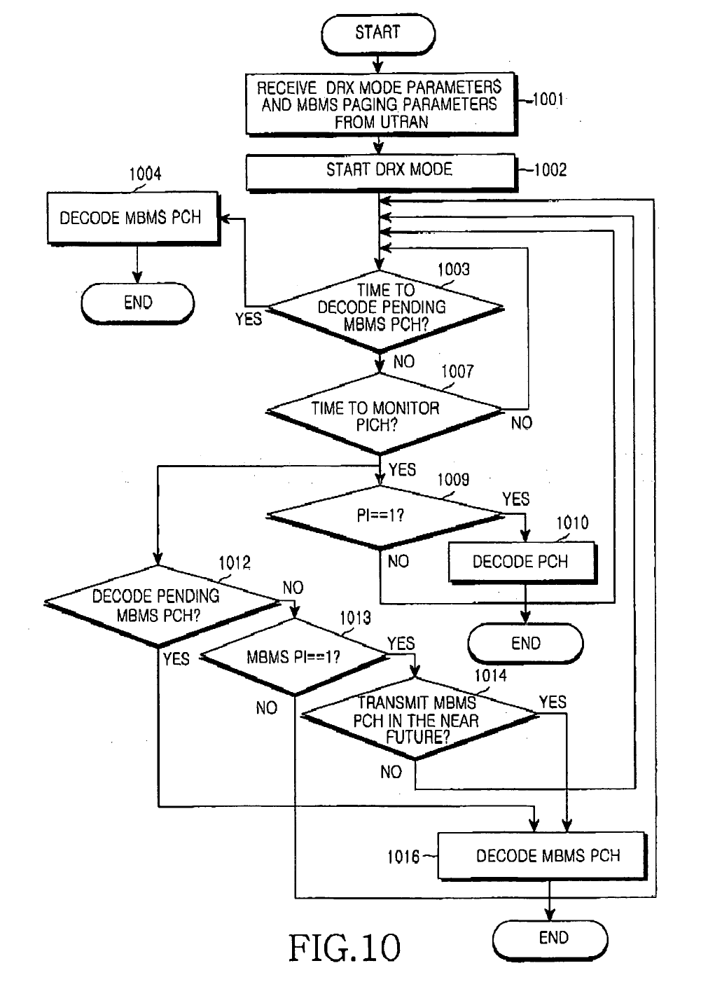

FIG. 10 is a flowchart illustrating an operating procedure of a UE according to the first and second embodiments of the present invention. An operation of a UE according to the first embodiment is identical to an operation of a UE according to the second embodiment except that an unused part of PICH is received. Therefore, it is assumed in FIG. 10 that an operation of a UE according to the present invention corresponds to operations of a UTRAN and a CN, described in connection with FIGS. 3 to 9.

Referring to FIG. 10, in step 1001, a UE receives the DRX parameters, such as a DRX cycle length and a PICH orthogonal variable spreading factor (OVSF) code, and MBMS paging-related parameters, i.e., the parameters-described in conjunction with Equation (1), from a network, or a UTRAN, and then proceeds to step 1002. In step 1002, the UE starts a DRX operation according to the received DRX parameters, and proceeds to step 1003. In the DRX operation, as described above, the UE receives the PICH and transitions to a sleep mode in durations other than the PICH reception duration according to the DRX parameters. In step 1003, the UE determines if it is time to receive a PCH signal for the MBMS paging associated with a previously analyzed PICH, i.e. a PCH signal for a pending MBMS. If it is determined that it is time to receive a PCH signal for an MBMS paging associated with a previously analyzed PICH, the UE proceeds to step 1004. In step 1004, the UE receives the PCH signal for the MBMS paging and then ends the procedure.

However, if it is determined in step 1003 that it is not time to receive a PCH signal for the MBMS paging associated with a previously analyzed PICH, the UE proceeds to step 1007. In step 1007, the UE determines if it is time to receive a PICH signal. If it is determined that it is not time to receive a PICH signal, the UE returns to step 1003. However, if it is determined that it is time to receive the PICH signal, the UE proceeds to step 1009. In step 1009, the UE receives the PICH signal at the corresponding time, demodulates the received PICH signal, and determines if the PI is set to 1 (PI=1) as a result of the PICH demodulation. If it is determined that the PI is set to 1, the UE proceeds to step 1010. In step 1010, the UE receives a PCH signal associated with the received PICH signal, demodulates the received PCH signal, and then ends the procedure. If it is determined in step 1009 that the PI is not set to 1, the UE returns to step 1003.

If it is determined in step 1007 that it is time to receive the PICH signal, the UE proceeds to step 1012 as well as step 1009. In step 1012, the UE determines if it is time to receive a PCH signal for MBMS paging associated with a previously analyzed PICH, i.e. a PCH signal for a pending MBMS paging. If it is determined that it is not time to receive a PCH signal for MBMS paging associated with a previously analyzed PICH, the UE proceeds to step 1013. In step 1013, the UE receives the PICH signal at the corresponding time, demodulates the received PICH signal, and determines if the MBMS PI in the unused part is set to 1 as a result of the PICH demodulation. If it is determined that the MBMS PI is not set to 1, the UE returns to step 1003. However, if it is determined in step 1013 that the MBMS PI is set to 1, the UE proceeds to step 1014. In step 1014, the UE determines if the PCH for transmitting the MBMS-related paging information will be received in the near future. Here, the UE can expect a time where the MBMS-related PCH signal is received, because it has already received from an RNC a transmission interval PAGING_INTERVAL of PCH over which the MBMS-related paging information is transmitted, and offset information OFFSET. The “near future” means a short time for which a gain by a DRX operation of the UE cannot be obtained. If it is determined that the MBMS-related PCH will not be received in the near future, the UE returns to step 1003. However, if it is determined in step 1014 that the MBMS-related PCH will be received in the near future, the UE proceeds to step 1016. In step 1016, the UE receives the MBMS-related PCH signal, demodulates the received MBMS-related PCH signal, and ends the procedure. However, if it is determined in step 1012 that it is time to receive the PCH signal for MBMS paging associated with the previously analyzed PICH, the UE proceeds to step 1016.

As understood from the foregoing description, the present invention can efficiently page UEs that are to receive an MBMS service by transmitting MBMS paging information in the methods described above. In addition, the present invention simplifies a signaling procedure between an RNC and a Node B for transmitting an MBMS paging control frame, and prevents an abnormal operation due to an error of the MBMS paging control frame.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting by a radio network controller (RNC) paging information over a paging indicator channel to a Node B in a mobile communication system including the RNC, at least one Node B connected to the RNC, and at least one user equipment (UE), the method comprising the steps of:
generating a paging control frame based on the paging information including paging indicator bit mapping information indicating paging for at least one broadcast service;
transmitting the paging control frame to the Node B; and
receiving a response message to the paging control frame from the Node B.

2. The method of claim 1, wherein the paging control frame includes a service identifier for identifying the broadcast service.

3. The method of claim 1, wherein the paging information includes transmission duration information of the paging indicator channel.

4. The method of claim 1, wherein the response message includes the paging information.

5. The method of claim 4, further comprising the step of retransmitting the paging control frame if the paging information in the paging control frame is not identical to the paging information in the response message.

6. The method of claim 1, further comprising the step of generating, if the paging information is changed, a new paging control frame based on the changed paging information, and transmitting the new paging control frame to the Node B.

7. A method for transmitting by a radio network controller (RNC) paging information over a paging indicator channel to a Node B in a mobile communication system including the RNC, at least one Node B connected to the RNC, and at least one user equipment (UE), the method comprising the steps of:
generating a paging control frame based on the paging information including paging indicator bit mapping information indicating paging for at least one broadcast service; and
repeatedly transmitting the paging control frame to the Node B for a predetermined number of times.

8. The method of claim 7, wherein the paging control frame includes a service identifier for identifying the broadcast service.

9. The method of claim 7, wherein the paging information includes transmission duration information of the paging indicator channel.

10. The method of claim 7, further comprising the step of generating, if the paging information is changed, a new paging control frame based on the changed paging information and repeatedly transmitting the new paging control frame to the Node B.

11. The method of claim 7, further comprising the step of generating, if the paging information is changed, a new paging control frame based on the changed paging information and repeatedly transmitting the new paging control frame to the Node B after repeated transmission of a previous paging control frame is completed.

12. A method for transmitting by a Node B a paging indicator indicating a start of a broadcast service to a user equipment (UE) in a mobile communication system including a radio network controller (RNC), at least one Node B connected to the RNC, and at least one UE, the method comprising the steps of:
receiving paging information including paging indicator bit mapping information indicating paging for at least one broadcast service, from the RNC through a paging control frame;
transmitting a response message including the paging information to the RNC in response to the paging control frame; and
transmitting the paging indicator to the UE based on the paging information.

13. The method of claim 12, wherein the paging information includes transmission duration information of the paging indicator channel.

14. The method of claim 12, further comprising the step of transmitting, if a paging control frame generated due to a change in the paging information is received, the paging indicator channel based on the changed paging information.

15. A method for transmitting by a Node B a paging indicator indicating a start of a broadcast service to a user equipment (UE) in a mobile communication system including a radio network controller (RNC), at least one Node B connected to the RNC, and at least one UE, the method comprising the steps of:
receiving paging information including paging indicator bit mapping information indicating paging for at least one broadcast service, through a paging control frame that is repeatedly transmitted from the RNC a predetermined number of times;
transmitting the paging indicator to the UE based on the repeatedly transmitted paging information; and
if the paging information changes, transmitting a new paging indicator to the UE based on the changed paging information.

16. The method of claim 15, wherein the paging information includes transmission duration information of the paging indicator channel.
